(19) United States
(12) Patent Application Publication
(10) Pub. No.: US 2006/0070523 A1
(43) Pub. Date: Apr. 6, 2006

(54) Sodium permanganate ethylene absorption agent

(75) Inventors: Ronald J. Magargee, Brandon, MS (US); William A. Ahrens, Tucson, AZ (US); Daniel T. Eyde, Tucson, AZ (US); Barry T. Smith, Tucson, AZ (US)

Correspondence Address: Scott R. Cox;LYNCH, COX, GILMAN & MAHAN, PSC, Ste. 2100, 500 W. Jefferson Street, Louisville, KY, 40202, US

(73) Assignees: Sud-Chemie, Inc., Louisville, KY (US); D & B Products Ltd., Tucson, AZ (US)

(21) Appl. No.: 10/957,855

(22) Filed: Oct. 4, 2004

(51) Int. Cl. B01D 53/02

(52) U.S. Cl. 95/143

(57) ABSTRACT

A process for absorbing ethylene comprising preparing a support material impregnated with an aqueous sodium permanganate solution, wherein the ethylene absorption agent is prepared by a process of selecting a support material, preparing a sodium permanganate solution, and impregnating the carrier material with the sodium permanganate solution.

### CROSS REFERENCE TO RELATED APPLICATION

NONE

### BACKGROUND

The present invention relates to compositions useful for absorbing ethylene and a process for production of ethylene absorbing compositions. More particularly, the invention relates to sodium permanganate impregnated compositions for absorbing ethylene, a process for production of those sodium permanganate impregnated compositions and a process of use of those compositions.

Ethylene, which is generated from organic material, such as produce and flowers, has a natural ripening effect on organic products. As a result ethylene can cause the premature ripening of fruits and the fast withering of flowers.

To remove ethylene from containers holding produce and flowers, freshness preserving agents designed to absorb the ethylene which is present in the environment, have been utilized. A broad range of freshness preserving agents exist including activated carbon, brominated charcoal, silver and aluminum chloride on alumina, activated zeolites, sodium chlorite saturated onto silica or zeolites, and most particularly, potassium permanganate impregnated in various carriers, particularly activated carbon, zeolite or sepiolite, as disclosed, for example, by U.S. Pat. Nos. 4,906,398 and 5,624,478 and EP 515 764. While other compositions, such as synthetic, double layered permanganate materials (U.S. Pat. No. 5,455,058), potassium bromate, and compounds containing a hydrosilyl group (U.S. Pat. No. 5,416,060) have been suggested as compositions useful to absorb ethylene, the commercially preferred material for the removal of ethylene from air streams is potassium permanganate impregnated into a carrier material, such as alumina.

Because the quantity of ethylene that can be removed from an air stream is related to the quantity of the permanganate ion that is present on the impregnated carrier, large quantities of potassium permanganate impregnated material often must be used to remove significant quantities of ethylene that may be present in the gas stream.

In the preparation of potassium permanganate impregnated materials, solid potassium permanganate crystals are first dissolved in water and then the solution is impregnated into the carrier material by conventional procedures. Unfortunately, the quantity of potassium permanganate that can be solubilized is limited to about 3 percent at room temperatures, with a maximum solubility of about 6 percent when the water temperature is increased close to boiling. The highest percentage of loading can be obtained generally only by mixing quantities of solid potassium permanganate with the carrier material. However, mixtures containing solid potassium permanganate are not as effective as absorbing agents as are carriers containing solubilized potassium permanganate because only the surface of the solid potassium permanganate is available to effectively absorb the ethylene.

Efforts have been made to increase the quantity of permanganate that can be absorbed by modifying the support material. In one methodology supports capable of absorbing larger quantities of aqueous solutions have been utilized, thereby increasing the overall quantity of the permanganate ions that are present on the support. High surface area alumina, magnesium aluminate, zeolites, aluminosilicates or mixtures thereof have been preferred as the support for this use. Sepiolite has been suggested as a particularly useful support for the absorption of large quantities of a potassium permanganate solution. When these supports are utilized, especially with saturated aqueous solutions of potassium permanganate heated to temperatures near boiling, the concentration of the potassium permanganate that can be deposited on the support may be increased to as high as about 6 percent by weight. Notwithstanding, even using extreme conditions, only relatively modest quantities of potassium permanganate can be impregnated into a support material because of the limit on the amount of solid potassium permanganate that can be solubilized. As a result it has been an object of the industry to produce enhanced ethylene absorbing materials containing even higher quantities of permanganate ion impregnated on a support.

This and other objects can be obtained by the composition of the invention, its process of manufacture, and the utilization of this composition for the adsorption of ethylene.

### SUMMARY OF INVENTION

The present invention is a composition for absorbing ethylene from a gas stream comprising a support material impregnated with an aqueous sodium permanganate solution, wherein the concentration of the permanganate impregnated on the support material exceeds about 2 percent and preferably comprises from about 5 to about 50 percent, on a dry weight basis, and more preferably 10-40 percent of the adsorbent composition.

The present invention further comprises a process for the production of an ethylene absorbing agent comprising selecting a support material which can absorb the desired quantity of a sodium permanganate solution, preparing the sodium permanganate solution at the desired concentration, and impregnating that support with the sodium permanganate solution.

The invention further comprises a process for the absorption of ethylene comprising placing the ethylene absorbing agent described above in a gas permeable container and introducing that container into an environment where quantities of ethylene may be produced or are already present.

### DETAILED DESCRIPTION OF THE INVENTION

The invention is a composition for absorbing ethylene from a gas stream comprising a support material impregnated with a solution of sodium permanganate.

The support material is chosen from various materials which can absorb significant quantities of a sodium permanganate solution and include materials such as diatomaceous earth, natural or synthetic zeolites, Celite, perlite, silica gel, aluminas, mica, magnesium aluminate, aluminosilicate, magnesium silicates, activated carbon, clays, such as bentonite, sepiolite, and attapulgite, vermiculite and mixtures thereof. Preferably the support is selected from materials with a capability of absorbing and holding significant quantities of an aqueous solution of sodium permanganate, preferably at least about 80 percent and more preferably from about 80 percent to about 300 percent, by weight. These materials preferably comprise diatomaceous earth and silica gel. In a more preferred embodiment the support material for the aqueous sodium permanganate solution is diatomaceous earth. Typically, diatomaceous earth can absorb at least its own weight of an aqueous sodium permanganate solution, and preferably up to at least about 130 percent of its weight of an aqueous solution of sodium permanganate. Other support materials, such as natural or synthetic zeolites, have lower water pick up and thus, are not capable of absorbing the same quantity of an aqueous sodium permanganate solution as can be absorbed by diatomaceous earth. In addition, some conventional, high absorbing support materials, such as silica gel, are more expensive than diatomaceous earth, making diatomaceous earth a more practical choice. In a preferred embodiment the support material also retains at least about 5 percent of water from the solubilized solution and preferably from about 10 to about 45 percent. Any material which can absorb large quantities of aqueous sodium permanganate solution and is inexpensive qualifies as the preferred support for the sodium permanganate solution.

The composition which is impregnated on and/or in the support material is an aqueous sodium permanganate solution. The preferred material that has been utilized for the absorption of ethylene for years has been an aqueous solution of potassium permanganate. However, the absorption capability of potassium permanganate impregnated materials for ethylene has been limited by the relatively low concentration of potassium permanganate that can be solubilized in an aqueous solution. At room temperature, the maximum quantity of potassium permanganate that can be completely solubilized in an aqueous solution is about 3-6 percent. Even when the temperature of the aqueous solution is increased to near boiling, the maximum quantity of the potassium permanganate that can be solubilized is about 6 percent or so.

It has been surprisingly discovered that significantly greater concentrations of sodium permanganate can be solubilized in an aqueous solution than potassium permanganate. The quantity of sodium permanganate that can be completely placed in solution, even at room temperature, is at least about 2 percent, preferably from about 5 to about 50 percent, by weight, and more preferably from about 10 to about 40 percent. At higher temperatures the quantity of sodium permanganate that can be solubilized is as high or about 60 percent or so, by weight. Thus, while the maximum concentration of an aqueous solution of potassium permanganate that can be completely impregnated is about 6 percent or so, it is possible to prepare sodium permanganate solutions with concentrations of sodium as high as about 60 percent, by weight. As a result it is possible to deposit far higher concentrations of an aqueous sodium permanganate solution on a support resulting with a significantly greater loading of permanganate ions than is possible when potassium permanganate is utilized.

Because the quantity of ethylene that can be absorbed generally has a direct relationship to the quantity of permanganate ions that is present, permanganate impregnated ethylene absorption materials based on impregnated sodium permanganate can be prepared which absorbs substantially greater quantities of ethylene than have previously been possible when the source for the permanganate has been potassium permanganate, even concentrated potassium permanganate solutions, even with the same overall quantities of absorbent material. It has also been surprisingly discovered that sodium permanganate impregnated support materials outperformed potassium impregnated carriers even when the concentration of the permanganate ion was the same on the respective supports. Further, it has been surprisingly discovered that these sodium impregnated carriers continue to absorb ethylene from a gas feedstream for a longer period of time than comparably impregnated support materials containing solubilized potassium permanganate.

The utilization of sodium permanganate dissolved in an aqueous solution and deposited on a support for the absorption of ethylene is a surprising utilization for sodium permanganate. Sodium permanganate in the prior art has been recognized and is used in fields such as industrial waste water treatment, preparation of printed circuit boards, pharmaceutical synthesis reactions, metal cleaning formulations, acid mine drainage and for air purification for the removal of hydrogen sulfide. (See, for example, LIQUOX, a trade name for an oxidant produced by Carus Chemical Company.) However, the use of sodium permanganate has been limited and has not been suggested for the adsorption of ethylene. In fact, high concentrations of aqueous solutions of sodium permanganate have only recently become commercially available. Sodium permanganate is more expense than potassium permanganate. In addition, solid sodium permanganate is more of a fire hazard than solid potassium permanganate. Thus, sodium permanganate has not been considered as a material that might be useful for the adsorption of ethylene. Notwithstanding, it has been surprisingly discovered that sodium permanganate, which has been dissolved in an aqueous solution at relatively high concentrations and then deposited on a support, can enhance the adsorption of ethylene and functions as a superior absorbent in comparison to conventional potassium permanganate impregnated materials.

The process for the production of the ethylene absorption agent of the invention includes selecting a support material, preferably a support with a high aqueous adsorption capability, preparing a sodium permanganate solution, and impregnating the support with the sodium permanganate solution. The particularly preferred support material is diatomaceous earth, as previously discussed. The concentration of the sodium permanganate solution that can be impregnated on the support is at least about 2, by weight, preferably from about 5-60 percent by weight and more preferably from about 10-60 percent by weight.

The support material is impregnated with the sodium permanganate solution by conventional procedures. In one procedure, the support material is placed within a drum which is rotated. The aqueous sodium permanganate solution at the preferred concentration is sprayed onto the carrier in liquid form as the support material is rotated within the drum. If desired, the impregnated support material may then be dried at a temperature from 30° C. to about 75° C. to remove excess water that may be present in the impregnated support. Alternatively, and to save costs, the concentration of water in the impregnated support can be maintained at a level that makes drying unnecessary.

Other conventional procedures for impregnating support materials with an aqueous solution can be used for the deposition or impregnation of sodium permanganate on the support.

The sodium permanganate impregnated support material can be utilized either as is or it can be placed within an ethylene absorption container which is gas permeable and is constructed of an ethylene permeable material, such as Tyvek®, a vapor permeable spun bonded polyolefin material. To produce said container, a quantity of the sodium permanganate impregnated support material is placed within the container and the container is then placed in a location where it can be used for the absorption of the ethylene. Because the container containing the sodium permanganate impregnated support material has a significantly higher capacity for the absorption of ethylene than containers containing comparable quantities of potassium permanganate impregnated materials because of the higher permanganate loading capacity of sodium permanganate, smaller quantities of the sodium permanganate impregnated composition need be used to obtain the same level of ethylene absorption. Alternatively, the same quantity of the sodium impregnated ethylene adsorption material can be utilized and it will continue to absorb ethylene for a longer period of time than has been possible for previous potassium permanganate impregnated material containers.

The use of a sodium permanganate solution and a comparison of its use with conventional potassium permanganate as an ethylene control agent is demonstrated by the following examples.

### EXAMPLE 1

On a lab bench 80 grams of a diatomaceous earth material obtained from Eagle Picher Minerals are placed within a rotating container with a baffle so the diatomaceous earth material is gently tumbled as it is rotated. 36.76 milliliters of a sodium permanganate solution (40 percent concentration) are sprayed on the surface of the diatomaceous earth during rotation. When all of the solution is sprayed, the impregnated diatomaceous earth product is removed and the quantity of sodium permanganate on a wet basis is determined to be 14.7 percent with a moisture content of 20.9 percent. The permanganate loading on the diatomaceous earth particles on a dry weight basis is determined to be 18.6 percent.

### EXAMPLE 2

In a lab 80 grams of a diatomaceous earth material obtained from Eagle Picher Minerals are placed within a container with a baffle so the diatomaceous earth material is gently tumbled as it is rotated. 36.76 milliliters of a sodium permanganate solution (40 percent concentration) are diluted with 15 milliliters of deionized water and sprayed on the surface of the diatomaceous earth as it is rotated. When all of the solution is sprayed on, the impregnated diatomaceous earth product is removed and the quantity of sodium permanganate on a wet basis is determined to be 12.6 percent with a moisture content of 29.5 percent. The permanganate loading on the diatomaceous earth particles on a dry weight basis is determined to be 17.9 percent.

### EXAMPLE 3

In the lab 80 grams of a diatomaceous earth material obtained from Eagle Picher Minerals are placed within a container with a baffle so the diatomaceous earth is gently tumbled as it is rotated. 36.76 milliliters of a sodium permanganate solution (40 percent concentration) are diluted with 30 milliliters deionized water and sprayed on the surface of the diatomaceous earth as it is rotated. When all of the solution is sprayed on, the impregnated diatomaceous earth product is removed and the quantity of sodium permanganate on a wet basis is determined to be 11.8 percent with a moisture content of 38.3 percent. The permanganate loading on the diatomaceous earth particles on a dry weight basis is determined to be 19.1 percent.

### COMPARATIVE EXAMPLE 4

In the lab 80 grams of a diatomaceous earth material obtained from Eagle Picher Minerals and 20 grams of solid potassium permanganate are placed within a rotating container with a baffle so the contents are gently tumbled as they are rotated. 70 milliliters of deionized water are sprayed on the contents of the container as it is rotated. When all the deionized water has been sprayed, the container is rotated an additional ten (10) minutes. The impregnated diatomaceous earth product with some remaining solid potassium permanganate are removed and the quantity of potassium permanganate on a wet basis is determined to be 9.5 percent with a moisture content of 40.2 percent. The permanganate loading on the diatomaceous earth particles on a dry weight basis is determined to be 15.9 percent.

### COMPARATIVE EXAMPLE 5

79 grams of clinoptilolite obtained from St. Cloud minerals, and 6 grams of solid potassium permanganate are placed in a rotating container with a baffle so the contents are gently tumbled as they are rotated. 15 milliliters of deionized water are sprayed on the surface of the contents as it is rotated. When all of the deionized water is sprayed on, the container is rotated an additional ten (10) minutes. The impregnated clinoptilolite with some solid potassium permanganate are removed from the container and the quantity of potassium permanganate on a wet basis is determined to be 3.9 percent with a moisture content of 15.5 percent. The permanganate loading on the diatomaceous earth particles on a dry weight basis is determined to be 4.6 percent.

### Comparative Results

1 gram of the composition prepared in each Example is packaged in a 1 inch (2.5 cm) by 1 inch (2.5 cm) package constructed of Tyvek®, a vapor permeable polyethylene material supplied by DuPont. This package is placed in a 30 cm by 30 cm aluminum foil bag containing a valve. Air is removed from the bag by applying a vacuum to the valve. The bag is flushed three time with nitrogen and evacuated. The bag is then filled with two liters of a mixture of ethylene and nitrogen containing 1 percent by weight ethylene. A gas sample is taken from the test bag each day and analyzed using a gas chromatograph manufactured by Perkin-Elmer, designated as an AutoSystem XL. Measurements of the quantity of ethylene present are obtained using a barrier bag filled with nitrogen. The quantity of the ethylene removed after 9 days is shown below:

| | Quantity of Ethylene Removed |
|---|---|
| Example | after 9 days (ml/gm) |
| Example 1 | 9.2 |
| Example 2 | 8.2 |
| Example 3 | 9.0 |
| Comparative Example 4 | 5.6 |
| Comparative Example 5 | 1.8 |

As is clear from these Examples, the quantity of ethylene that is removed using the sodium permanganate impregnated material is substantially higher than that used with conventional potassium permanganate even when the percentage of potassium permanganate used is relatively high, as shown in Comparative Example 4. Further, the sodium impregnated material outperformed the potassium permanganate material even when the permanganate loading was similar.

The preferred embodiments and modes of operation of the present invention have been described in the forgoing specification. The invention, which is intended to be protected herein, however, is not to be construed or limited to the particular terms of disclosure as these are to be regarded as being illustrative rather than restrictive. Variations and changes may be made by those skilled in the art without departing from the scope of the invention.

1. A process for absorbing ethylene comprising contacting a gas stream containing ethylene with a composition comprising a support material impregnated with sodium permanganate.

2. The process of claim 1, wherein the concentration of the sodium permanganate by weight impregnated in the support material is at least about 2 percent.

3. The process of claim 1, wherein the concentration of the sodium permanganate by weight impregnated in the support material is from about 10 to about 60 percent.

4. The process of claim 1, wherein the support material is selected from the group consisting of diatomaceous earth, natural or synthetic zeolites, Celite, perlite, silica gel, aluminas, magnesium aluminate, aluminosilicates, magnesium silicates, active carbon, clays such as bentonite, sepiolite, attapulgite, vermiculite, mica, and mixtures thereof.

5. The process of claim 4, wherein the support material comprises diatomaceous earth.

6. The process of claim 1, wherein the support material retains water in an amount of at least about 5 percent of the weight of the carrier.

7. The process of claim 1, wherein the support material retains water in an amount from about 10 to about 45 percent.

8. The process of claim 1, wherein the sodium permanganate is impregnated in the support material as an aqueous sodium permanganate solution.

9. The process of claim 1 further comprising placing the sodium impregnated support material within an ethylene permeable container.

10. A process for production of an ethylene absorbing agent comprising
selecting a support material,
preparing a sodium permanganate solution, and
impregnating the carrier with the sodium permanganate solution to produce the ethylene absorbing agent.

11. The process of claim 10, wherein the support material is selected from diatomaceous earth, natural or synthetic zeolites, Celite, perlite, silica gel, aluminas, magnesium aluminate, aluminosilicates, magnesium silicates, active carbon, clays such as bentonite, sepiolite, attapulgite, vermiculite, mica, and mixtures thereof.

12. The process of claim 11, wherein the support material comprises diatomaceous earth.

13. The process of claim 10, wherein the sodium permanganate solution comprises an aqueous sodium permanganate solution wherein the concentration of sodium permanganate in the solution is at least about 2 percent.

14. The process of claim 10, wherein the concentration of the sodium permanganate in the aqueous sodium permanganate solution is from about 10 percent to about 50 percent.

15. The process of claim 10 further comprising drying the impregnated support material to reduce the water content to 5 percent or less.

16. An ethylene absorption material produced by the process of claim 1.
